(19) United States
(12) Patent Application Publication
(10) Pub. No.: US 2005/0129367 A1
(43) Pub. Date: Jun. 16, 2005

(54) Method and apparatus for angled fiber optical attenuation

(75) Inventors: Dennis G. Koshinz, Bellevue, WA (US); Eric Y. Chan, Mercer Island, WA (US)

Correspondence Address: FITCH EVEN TABIN AND FLANNERY, 120 SOUTH LA SALLE STREET, SUITE 1600, CHICAGO, IL, 60603-3406, US

(73) Assignee: The Boeing Company, a Delaware corporation, Chicago, IL (US)

(21) Appl. No.: 10/735,016

(22) Filed: Dec. 12, 2003

(51) Int. Cl. G02B 6/26; G02B 6/42

(52) U.S. Cl. 385/42; 385/47; 385/88; 385/89

(57) ABSTRACT

Opto-electronic array modules using a Vertical Cavity Surface Emitting Laser (VCSEL) and photodiode arrays have polished fiber end face angles varying from a 45 degree angle to attenuate the amount of light entering the fiber in order to eliminate saturation of the opto-electronic receiver in a fiber optic transceiver system. Varying angles may be used when coupling light between the fiber and an active device to adjust the attenuation.

### BACKGROUND OF THE INVENTION

The present invention relates generally to fiber optic devices, and more particularly to fiber optic light attenuation when coupling light between a fiber and an active device.

Fiber optic data links require a transmitter source to transmit light to a receiver via optical fiber. In order to effectively couple light between a fiber and an active device (laser or light emitting diode (LED)), the end of the fiber is polished to a 45 degree angle. This 45 degree angle allows coupling of light into or out of the fiber at a 90 degree angle to the fiber. The 45 degree angled surface acts as an internal mirror reflecting light into or out of the fiber core. In order for the system to transmit data, the receiver requires optical power within a certain level. If there is more optical power than required the receiver will become saturated. To avoid saturation, manufacturers use three traditional techniques to attenuate optical power: 1) a coated window between fibers and photodiode elements, 2) fiber attenuator or airgap between connectors and 3) coating the fiber ends to attenuate optical power.

All of these attenuation techniques increase costs, or are not highly robust and practical. Coating is expensive and increases the risk of damage to the fiber. Fiber air spaced attenuators add to the cost by creating another fiber connection between the transmit (Tx) and receive (Rx), increasing the weight and size of the fiber link. Adding extra fiber to attain the desired attenuation could mean adding an extra kilometer or more of fiber to a 1 meter fiber link, which would add cost and weight and take up valuable space.

There is thus a need in the art for systems and methods that couple light between a fiber and an active device and provide practical, robust and inexpensive attenuation of the optical power between the active device and the fiber to avoid saturation of a receiver.

### SUMMARY OF THE INVENTION

The present invention advantageously addresses the needs above as well as other needs by providing an inexpensive, robust and practical method and apparatus for angled fiber optical attenuation to avoid saturation of the receiver.

In one embodiment, the invention can be characterized as a fiber optic device comprising an optical fiber with a fiber core having a fiber core cladding interface. The optical fiber has an angled polished end surface that is at an acute angle other than 45 degrees from a side of the fiber.

In another embodiment, the invention can be characterized as a fiber optic device comprising a plurality of optical fibers operationally coupled together to form an opto-electronic array module. There is a fiber core within each of the optical fibers, each core having a fiber core cladding interface. Also at least two of the optical fibers has an angled polished end surface. The polished end surface is at an acute angle other than 45 degrees from a side of the fiber.

In yet another embodiment, the invention can be characterized as a method for attenuating the amount of light entering an optical fiber comprising the steps of receiving light into an optical fiber and reflecting the light off a polished end surface of the optical fiber into a core of the optical fiber. The polished end surface is at an acute angle other than 45 degrees from a side of the optical fiber, thereby attenuating the light.

A better understanding of the features and advantages of the present invention will be obtained by reference to the following detailed description of the invention and accompanying drawings which set forth an illustrative embodiment in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a cross sectional side view of a fiber optic device according to an embodiment of the present invention;

FIG. 2 is a graph showing fiber angle vs. optical attenuation according to an embodiment of the present invention; and

FIG. 3 is a cross sectional side view of a fiber optic device according to an alternative embodiment of the present invention.

Corresponding reference characters indicate corresponding components throughout the several views of the drawings.

### DETAILED DESCRIPTION OF THE PREFERRED EMBODIMENTS

The following description of the presently contemplated best mode of practicing the invention is not to be taken in a limiting sense, but is made merely for the purpose of describing the general principles of the invention. The scope of the invention should be determined with reference to the claims.

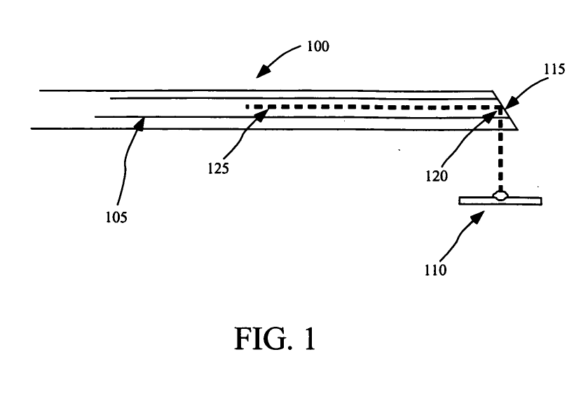

Referring to FIG. 1, shown is a cross sectional side view of a fiber optic device according to an embodiment of the present invention.

Shown is an optical fiber 100, a fiber core cladding interface 105 of the optical fiber 100 and an active device 110 (a laser or LED, for example). The optical fiber 100 has a polished surface 115. The internal reflection 120 from the polished surface 115 is shown as well as the optical ray 125 guided by the fiber 100.

The polished surface 115 on the end of the optical fiber 100 is at an angle below 45 degrees. Preferably, the angle is no less than approximately 40 degrees, but may be lower.

Light from the active device 110 enters the optical fiber 100 substantially perpendicular to a side of the optical fiber 100 before being reflected 120 by the polished surface 115 into the optical fiber 100. The optical ray 125 is then guided by the fiber core cladding interface 105 of the optical fiber 100. Due to the fact that the polished surface is at an angle different than 45 degrees the amount of light entering the fiber 100 is attenuated to eliminate saturation of an opto-electronic receiver (not shown) in a fiber optic transceiver system. The larger the difference of the angle of the polished surface 115 is from 45 degrees, the higher the degree of attenuation.

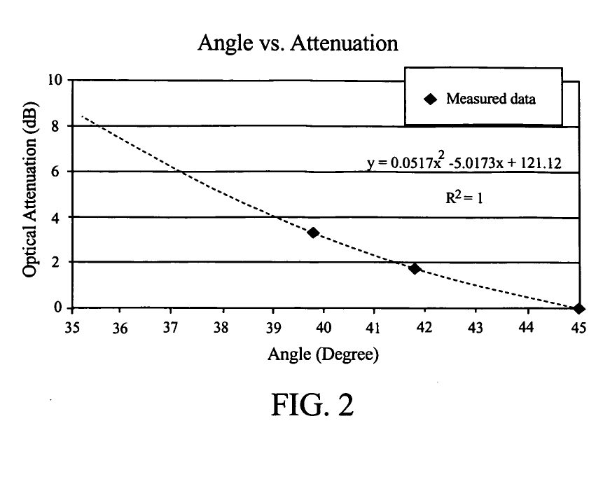

Referring next to FIG. 2 depicted is a graph showing fiber angle vs. optical attenuation according to an embodiment of the present invention. Such attenuation is useful in opto-electronic array modules that use Vertical Cavity Surface Emitting Laser (VCSEL) and photodiode arrays. During development of 12-channel transceiver arrays, the above attenuation approach was tested and it was found that by attenuating the coupling of light into the fibers 100 by −3 dBm, the eye diagram and bit error rate (BER) showed significant improvement at 2.0 Gb/s data rate for direct, “back to back” transceiver link testing.

As shown in the graph of FIG. 2, the polished surface 115 of the fiber 100 was angled to 40 degrees to achieve a −3 dBm attenuation change in the light coupling between the fiber and VCSEL array. This technique may also work with data rates above or below 2.0 Gb/s. The angle of the polished surface 115 can be varied according to the graph of FIG. 2 to achieve a desired attenuation. Typically, a desirable change in attenuation is of approximately 5 degrees or less. In most cases attenuation steps of 1.0 dBm is acceptable.

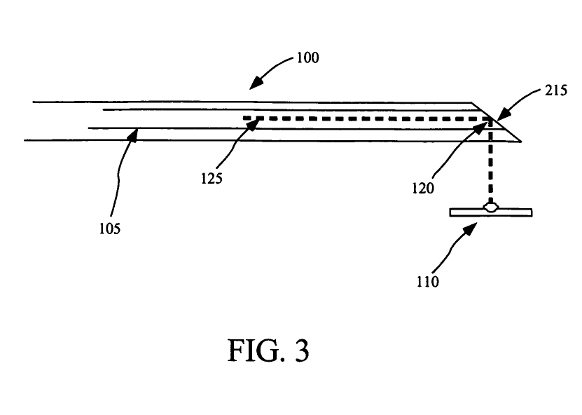

Referring next to FIG. 3, shown is a cross sectional side view of a fiber optic device according to an alternative embodiment of the present invention.

Shown is an optical fiber 100, a fiber core cladding interface 105 of the optical fiber 100 and an active device 110 (a laser or LED, for example). The optical fiber 100 has a polished surface 215. The internal reflection 120 from the polished surface 215 is shown as well as the optical ray 125 guided by the fiber 100.

The polished surface 215 on the end of the optical fiber 100 is at an angle above 45 degrees. Preferably, the angle is no more than approximately 45 degrees, but may be higher.

The amount of light entering the fiber 100 having the polished surface 215 above 45 degrees is attenuated in the same fashion as described above for a polished surface at an angle below 45 degrees. Likewise, the larger the difference of the angle of the polished surface 215 is from 45 degrees, the higher the degree of attenuation results.

While the invention herein disclosed has been described by means of specific embodiments and applications thereof, numerous modifications and variations could be made thereto by those skilled in the art without departing from the scope of the invention set forth in the claims.

1. A fiber optic device comprising:
an optical fiber;
a fiber core within the optical fiber having a fiber core cladding interface; and
an angled polished end surface on an end of the optical fiber, the polished end surface at an acute angle other than 45 degrees from a side of the fiber.

2. The apparatus of claim 1 further comprising:
an active device operationally coupled to the optical fiber such that light from the active device is attenuated by the polished surface and reflected into the fiber core.

3. The apparatus of claim 2 wherein the active device is a vertical cavity surface emitting laser.

4. The apparatus of claim 2 wherein the active device is a light emitting diode.

5. The apparatus of claim 2 wherein the polished end surface is at an angle between approximately 39 and 45 degrees from a side of the fiber.

6. The apparatus of claim 2 wherein the polished end surface is at an angle between approximately 45 and 51 degrees from a side of the fiber.

7. The apparatus of claim 2 wherein the polished end surface is at an angle of approximately 40 degrees from a side of the fiber.

8. The apparatus of claim 2 wherein the polished end surface is at an angle sufficient to avoid saturation of an opto-electronic receiver.

9. A fiber optic device comprising:
a plurality of optical fibers operationally coupled together to form an opto-electronic array module;
a fiber core within each of the optical fibers, the fiber core having a fiber core cladding interface; and
an angled polished end surface on at least two of the optical fibers, the polished end surface at an acute angle other than 45 degrees from a side of the fiber.

10. The apparatus of claim 9 further comprising:
an active device operationally coupled to the optical fibers such that light from the active device is attenuated by the angled polished end surface and reflected into the fiber core.

11. The apparatus of claim 10 wherein the active device is a vertical cavity surface emitting laser.

12. The apparatus of claim 10 wherein the active device is a light emitting diode.

13. The apparatus of claim 10 wherein the polished end surface is at an angle between approximately 39 and 45 degrees from a side of the fiber.

14. The apparatus of claim 10 wherein the polished end surface is at an angle between approximately 45 and 51 degrees from a side of the fiber.

15. The apparatus of claim 10 wherein the polished end surface is at an angle of approximately 40 degrees from a side of the fiber.

16. The apparatus of claim 10 wherein the polished end surface is at an angle sufficient to avoid saturation of an opto-electronic receiver.

17. A method for attenuating the amount of light entering an optical fiber comprising the steps of:
receiving light into an optical fiber; and
reflecting the light off a polished end surface of the optical fiber into a core of the optical fiber, the polished end surface at an acute angle other than 45 degrees from a side of the optical fiber, thereby attenuating the light.

18. The method of claim 17 wherein the polished end surface is at an angle sufficient to avoid saturation of an opto-electronic receiver.

19. A method for attenuating the amount of light entering an optical fiber comprising the steps of:
polishing an end surface of the optical fiber at an acute angle other than 45 degrees from a side of the optical fiber; and
reflecting light off the polished end Surface of the optical fiber into a core of the optical fiber.

20. The method of claim 19 wherein the polished end surface is at an angle sufficient to avoid saturation of an opto-electronic receiver.

21. A method of coupling light between an optical fiber and an active device comprising:
receiving light into the optical fiber from the active device; and
reflecting the light off a polished end surface of the optical fiber into a core of the optical fiber, the polished end surface at an acute angle other than 45 degrees from a side of the optical fiber.

22. The method of claim 21 wherein the polished end surface is at an angle sufficient to avoid saturation of an opto-electronic receiver.
